(19) United States
(12) Patent Application Publication
(10) Pub. No.: US 2009/0046154 A1
(43) Pub. Date: Feb. 19, 2009

(54) SYSTEM AND METHOD FOR TESTING A VIDEO SIGNAL GENERATOR

(75) Inventors: SHI-YUAN TAO, Shenzhen (CN); REN-BO HUANG, Shenzhen (CN); XIAO-LIN GAN, Shenzhen (CN); YU-KUANG HO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/957,495

(22) Filed: Dec. 17, 2007

(30) Foreign Application Priority Data
Aug. 15, 2007 (CN) 200710201373.5

(51) Int. Cl. H04N 17/00

(52) U.S. Cl. 348/181; 348/E17.001

(57) ABSTRACT

An exemplary method for testing a video signal generator is provided. The method includes: setting test parameters of the video signal generator to perform a function test; generating signals based on the test parameters through the video generator; controlling a standard measuring apparatus to receive the signals and to convert the signals into test values; determining whether the video signal generator passes the function test by comparing the test values with a standard working range of the video signal generators; and generating a test report based on the test values and the test parameters. A system for testing a video signal generator is also provided. By utilizing the present invention, errors can be reduced and test efficiency can be enhanced.

### BACKGROUND OF THE INVENTION

1. Field of the Invention

The present invention relates to systems and methods for testing signal generators, particularly to a system and method for testing a video signal generator.

2. Description of Related Art

For a video display to operate a high resolution with high fidelity of colors, the quality of a video signal generator is very important. For this reason, a function test needs to be performed on the video signal generator accurately and efficiently to check the quality of the generator after the video signal generator is produced.

In a conventional test method, the video signal generator is usually tested manually. For example, an operator needs to manually input parameters. Furthermore, the video signal generator is necessary to be tested more than once until the operator is satisfactory that test results of the video signal generator are accurate. Every time the video signal generator is tested, the operator has to go back to the beginning and repeat the test flow manually. For this reason, the test method is heavy and complicated, and the test speed is slow. In addition, components or assemblies of the video signal generator would be damaged through repeatedly testing. Test reports also need to be manually inputted, thus, the test reports may consist of typo errors.

What is needed, therefore, is a system and method for testing the video signal generator with great efficiency and speed, which can test the video signal generator accurately, and generates a test report automatically.

### SUMMARY OF THE INVENTION

A system for testing a video signal generator is disclosed. The system includes a standard measuring apparatus and a video signal generator that is connected with the video signal generator via a plurality of conducting lines. The computer is electronically linked with the standard measuring apparatus and the video signal generator. The computer being programmed to include a setting module, a test module, and a report generating module. The setting module is configured for setting test parameters, wherein the video signal generator generates signals based on the test parameters to perform a function test. The test module is configured for controlling the standard measuring apparatus to receive the signals generated by the video signal generator and to convert the signals into test values. The report generating module is configured for determining whether the video signal generator passes the function test by comparing the test values with a standard working range of the video signal generator, and generating a test report based on the test values, the test parameters and the standard working range.

A computer-enabled method for testing a video signal generator includes: setting test parameters of the video signal generator to perform a function test; generating signals based on the test parameters; controlling a standard measuring apparatus to receive the signals and to convert the signals into test values; determining whether the video signal generator passes the function test by comparing the test values with a standard working range of the video signal generators; and generating a test report based on the test values and the test parameters.

Other novel features of the indicated invention will become more apparent from the following detailed description of the preferred embodiment when taken in conjunction with the accompanying drawings.

### BRIEF DESCRIPTION OF THE DRAWINGS

FIG. 1 is a schematic diagram illustrating an application environment of a system for testing a video signal generator in accordance with one embodiment.

FIG. 2 is a schematic diagram of software function modules of a test program of FIG. 1.

FIG. 3 is a schematic diagram illustrating a partial test report of a voltage test;

FIG. 4 is a flowchart of a preferred method for testing a video signal generator in accordance with another embodiment.

### DETAILED DESCRIPTION OF THE INVENTION

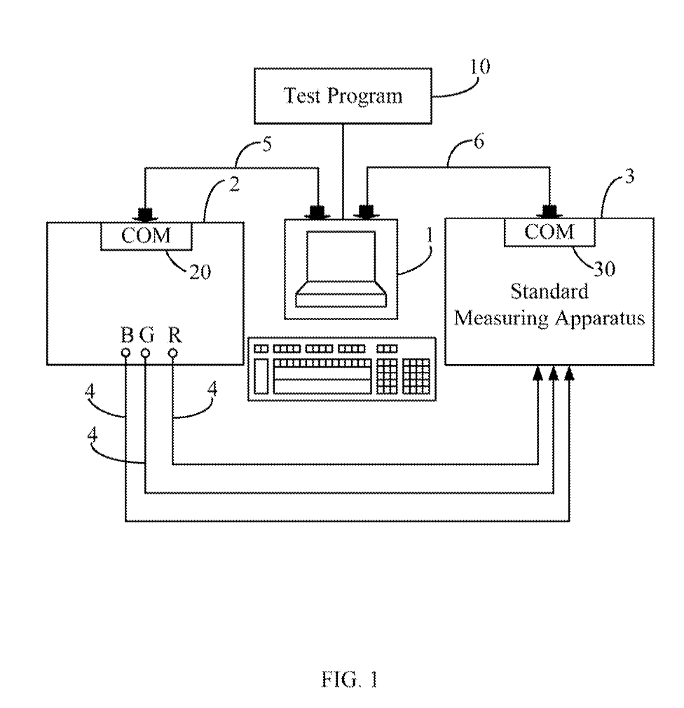

FIG. 1 is a schematic diagram illustrating an application environment of a system for testing a video signal generator (hereinafter, “the system”) in accordance with one embodiment. The system typically includes a computer 1, a video signal generator 2 and a standard measuring apparatus 3. The computer 1 includes two ports: a first COM port and a second COM port. The video signal generator 2 includes at least one COM port 20 that is connected with the first COM port of the computer 1 via a first data line 5. The standard measuring apparatus 3 includes, but not limited to, a COM port 30 that is connected with the second COM port of the computer 1 via a second data line 6. The video signal generator 2 is electronically linked with the standard measuring apparatus 3 via a plurality of conducting lines 4.

In the preferred embodiment, the computer 1 is installed with a test program 10, which can provide a graphical user interface on the computer 1 for setting test parameters. The test parameters include voltage-test parameters and frequency-test parameters. The computer 1 invokes the test program 10 that transmits the test parameters to the video signal generator 2 via the COM port 20, and performs various function tests on the video signal generator 2. The function tests may include a voltage test and a frequency test.

For example, the “chroma 2326” is used to illustrate the video signal generator 2. The “chroma 2326” typically includes three channels: a red channel (hereinafter “R channel”), a green channel (hereinafter “G channel”), and a blue channel (hereinafter “B channel”). The video signal generator 2 is connected to the R channel, the G channel, and the B channel of the standard measuring apparatus 3 correspondingly via the conducting lines 4. If the operator wants to perform the voltage test on the video signal generator 2, a data collector is adopted as the standard measuring apparatus 3. If the operator wants to perform the frequency test, a cymometer is adopted as the standard measuring apparatus 3.

As known in the art, the video signal generator 2 corresponds to a standard working range. The standard working range generally includes a maximum voltage value, a minimum voltage value, a maximum frequency value, and a minimum frequency value.

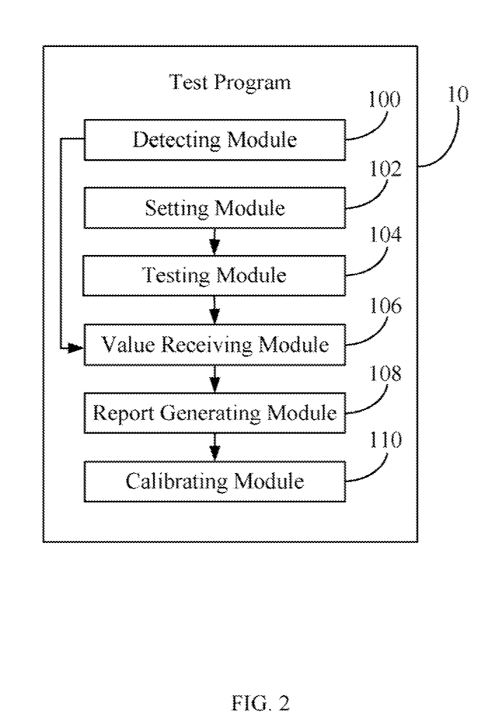

FIG. 2 is a schematic diagram of software function modules of the test program 10 in FIG. 1. The test program 10 typically includes a detecting module 100, a setting module 102, a test module 104, a value receiving module 106, a report generating module 108, and a calibrating module 110.

The detecting module 100 is configured for detecting whether the computer 1 has successfully connected with the standard measuring apparatus 3, and alerting the operator of a connection error if the computer 1 is not connected with the standard measuring apparatus 3. Otherwise, if the detecting module 100 detects that the computer 1 has successfully connected with the standard measuring apparatus 3, the computer 1 remotely controls the standard measuring apparatus 3 to receive signals via the second data line 6.

The setting module 102 is configured for setting the test parameters to test the functions of the video signal generator 2. The test parameters include the voltage-test parameters and the frequency-test parameters.

In the preferred embodiment, the data collector is adopted as the standard measuring apparatus 3 to perform the voltage test on the video signal generator 2. The setting module 102 is configured for setting the voltage-test parameters and initializing the data collector to receive the signals output by the video signal generator 2. The voltage-test parameters typically include an offset of a direct current of RGB (red, green, blue) pictures (depicted as “DC offset (R, G, B)”), a synchronous level of the green picture (depicted as “SYNC level (G)”), luminances and chromatism values of the RGB pictures.

In another preferred embodiment, the cymometer is adopted as the standard measuring apparatus 3 to perform the frequency test of the video signal generator 2. The setting module 102 is configured for setting the frequency-test parameters by selecting a test frequency stored in the video signal generator 2, and setting a functional mode of the cymometer to a mode of a phase locked logic unit (hereinafter “PLL unit”).

The test module 104 is configured for performing the voltage test or the frequency test based on the test parameters set by the setting module 102. Namely, the video signal generator 2 receives the test parameters from the setting module 102, and generates signals according to the test parameters. The test module 104 controls the standard measuring apparatus 3 to receive the signals through the R channel, the G channel, and the B channel, to convert the signals into test values, and to transmit the test values to the computer 1. The test values may be voltage values or frequencies.

The value receiving module 106 is configured for receiving the test values from the test module 104.

The report generating module 108 is configured for determining whether the video signal generator 2 passes the function test by comparing the test values with the standard working range, and for generating a test report based on the test values, the test parameters, and the standard working range of the video signal generator 2.

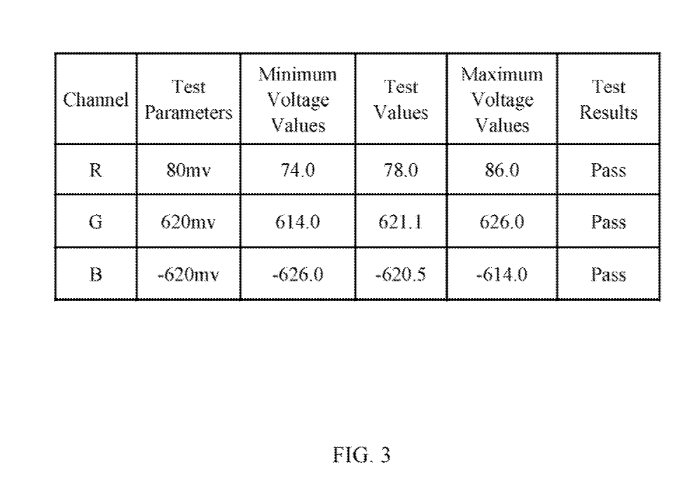

If the video signal generator 2 does not pass the function test, the calibrating module 110 is configured for calibrating the test values according to the standard working range, sending the calibrated voltage values to the video signal generator 2 in order to calibrate the video signal generator 2, and obtaining a calibrated result. The report generating module 108 is further configured for updating the test report according to the calibrated result. FIG. 3 is a schematic diagram illustrating a partial test report of the voltage test. In the preferred embodiment, the type of the test report is not limited to the type of the partial test report of FIG. 3.

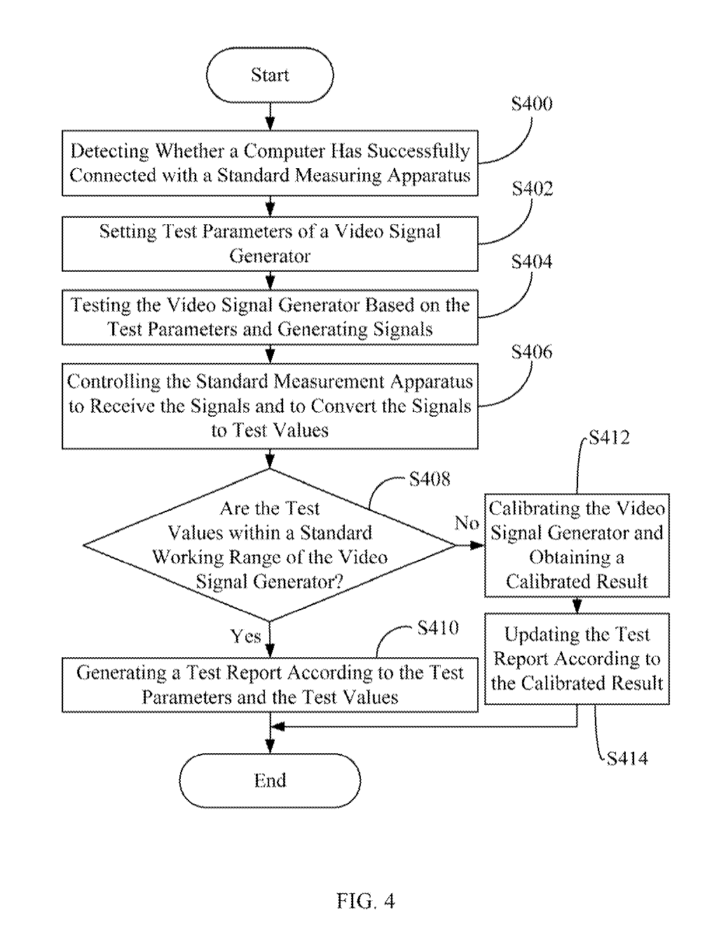

FIG. 4 is a flowchart of a preferred method for testing a video signal generator in accordance with another embodiment. The present embodiment gives an example for describing a method of a voltage test. Before testing the video signal generator 2, the operator connects the computer 1 with the video signal generator 2 and the standard measuring apparatus 3 as described above in FIG. 1. In the preferred embodiment, the standard measuring apparatus 3 is the data collector. The computer 1 invokes the test program 10 for remotely controlling the video signal generator 2 via the first data line 5, and controlling the data collector via the second data line 6 so as to perform the voltage test on the video signal generator 2.

In step S400, the detecting module 100 detects whether the computer 1 has successfully connected with the data collector, and alerting the operator of the connection error if the computer 1 is not connected with the data collector.

Otherwise, if the detecting module 100 detects the computer 1 has successfully connected with the data collector, in step S402, the setting module 102 sets the voltage-test parameters, and initializes the data collector for receiving the signals output by the video signal generator 2. The voltage-test parameters typically include the DC offset (R, G, B), the SYNC level (G), the luminances and the chromatism values of the RGB pictures.

In step S404, the test module 104 performs the voltage test based on the test parameters. Namely, the video signal generator 2 receives the test parameters from the setting module 102 of the computer 1, and generates the signals according to the test parameters.

In step S406, the test module 104 controls the data collector to receive the signals through the R channel, the G channel, and the B channel, to convert the signals to test values, and to transmit the test values to the computer 1. The value receiving module 106 receives the test values from the data collector. In the step S406, the test values are voltage values.

In step S408, the report generating module 108 determines whether the video signal generator 2 passes the voltage test by comparing the voltage values with the standard working range.

If the video signal generator 2 passes the voltage test, namely the voltage values are within the standard working range, in step S410, the report generating module 108 generates the test report based on the voltage values, the voltage-test parameters and the standard working range of the video signal generator 2.

Otherwise, if the voltage values are not within the standard working range, namely the video signal generator 2 does not pass the voltage test, in step S412, the calibrating module 110 calibrates the test values according to the standard working range, sends the calibrated voltage values to the video signal generator 2 in order to calibrate the video signal generator 2, and obtains a calibrated result.

In step S414, the report generating module 108 updates the test report according to the calibrated result.

That is, after the video signal generator 2 receives the calibrated voltage values, if the test values are also not within the standard working range, the video signal generator 2 does not pass the function test. That is, the calibrated result is that the video signal generator 2 is an ineligible signal generator. Otherwise, after the video signal generator 2 receives the calibrated voltage values, if the test values are within the standard working range, the calibrated result is that the video signal generator 2 is an eligible signal generator.

When the operator wants to perform the frequency-test, the cymometer is adopted as the standard measuring apparatus 3. The method for testing the frequency of the cymometer is similar to the method for testing the voltage of the data collector, excepting for the step S402 and step S406 of FIG. 4. That is, in step S402, the setting module 102 sets the frequency-test parameters by selecting a test frequency stored in the video signal generator 2, and sets the functional mode of the cymometer as the mode of the PLL unit. For example, the video signal generator 2 has multiple frequencies, for example, 125 MHZ, 137.5 MHZ, 150 MHZ, and 162.5 MHZ, to be selected by the setting module 102. In step S406, the test values are frequencies.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for testing a video signal generator, comprising:
a standard measuring apparatus connected with the video signal generator via a plurality of conducting lines;
a computer electronically linked with the standard measuring apparatus and the video signal generator;
the computer being programmed to comprise:
a setting module configured for setting test parameters, wherein the video signal generator generates signals based on the test parameters to perform a function test;
a test module configured for controlling the standard measuring apparatus to receive the signals generated by the video signal generator and to convert the signals into test values; and
a report generating module configured for determining whether the video signal generator passes the function test by comparing the test values with a standard working range of the video signal generator, and generating a test report based on the test values, the test parameters and the standard working range.

2. The system for testing a video signal generator as described in claim 1, further comprising a calibrating module configured for calibrating the test values according to the standard working range, sending the calibrated values to the video signal generator to calibrate the video signal generator, and obtaining a calibrated result.

3. The system for testing a video signal generator as described in claim 2, wherein the report generating module is further configured for updating the test report according to the calibrated result.

4. The system for testing a video signal generator as described in claim 1, wherein the test parameters comprise voltage-test parameters and frequency-test parameters.

5. The system for testing a video signal generator as described in claim 4, wherein the voltage-test parameters comprise an offset of a direct current of a red picture, a green picture or a blue picture, a synchronous level of the green picture, and a luminance and a chromatism value of each of the red picture, the green picture and the blue picture.

6. The system for testing a video signal generator as described in claim 4, wherein the frequency-test parameters comprise a test frequency selected from the video signal generator, and a plurality of functional modes of the standard measuring apparatus as a mode of a phase locked logic unit.

7. A computer-enabled method for testing video signal generator, the method comprising:
setting test parameters of the video signal generator to perform a function test;
generating signals based on the test parameters;
controlling a standard measuring apparatus to receive the signals and to convert the signals into test values;
determining whether the video signal generator passes the function test by comparing the test values with a standard working range of the video signal generators; and
generating a test report based on the test values and the test parameters.

8. The method for testing video signal generator as described in claim 7, further comprising steps of:
calibrating the test values according to the standard working range if the video signal generator does not pass the function test;
sending the calibrated values to the video signal generator to calibrate the video signal generator, and obtaining a calibrated result; and
updating the test report according to the calibrated result.

9. The method for testing video signal generator as described in claim 7, wherein the function test comprises a voltage test and a frequency test.

10. The method for testing video signal generator as described in claim 9, wherein the step of setting test parameters of the video signal generator comprising steps of:
setting voltage-test parameters if an operator wants to perform the voltage test; or
setting frequency-test parameters if the operator wants to perform the frequency test.

11. The method for testing video signal generator as described in claim 9, wherein a data collector is adopted as the standard measuring apparatus when the voltage test is performed.

12. The method for testing video signal generator as described in claim 9, wherein a cymometer is adopted as the standard measuring apparatus when the frequency test is performed.

13. The method for testing video signal generator as described in claim 9, wherein the voltage-test parameters comprise an offset of a direct current of a red picture, a green picture or a blue picture, a synchronous level of the green picture, and a luminance and a chromatism value of each of the red picture, the green picture and the blue picture.

14. The method for testing video signal generator as described in claim 9, wherein the frequency-test parameters comprise a test frequency selected from the video signal generator, and a plurality of functional modes of the standard measuring apparatus as a mode of a phase locked logic unit.
